(19) United States
(12) Patent Application Publication
(10) Pub. No.: US 2015/0229812 A1
(43) Pub. Date: Aug. 13, 2015

(54) Clothing Accessory

(71) Applicant: Matt Sandy, Elmsford, NY (US)

(72) Inventor: Matt Sandy, Elmsford, NY (US)

(21) Appl. No.: 13/999,304

(22) Filed: Feb. 10, 2014

(51) Int. Cl. H04N 5/225; A45F 5/02

(52) U.S. Cl. CPC H04N 5/2252; A45F 5/02

(57) ABSTRACT

A clothing accessory has at least one element of clothing accessory wearable by a user, and a recording camera associated with the element of clothing accessory and carrying out a recording process while being associated with the element of clothing accessory.

### BACKGROUND OF THE INVENTION

The present invention relates to a clothing accessory wearable by users on various occasions or attachable to other objects.

Clothing accessories, such as brooches, pins, and neck wearable medallions, are widely known and worn by users for the major purposes of covering parts of clothes. It is believed however that it would be advisable to construct these accessories in such a way that, in addition to their main function of covering clothes, they can also perform other different functions which are not related to the wearing function only, but carry out other actions which can be important in lives of people.

### SUMMARY OF THE INVENTION

Accordingly, it is an object of the present invention to provide a clothing accessory which is a further improvement of the existing clothing accessories.

In keeping with these objects and with others which will become apparent hereinafter one feature of the present invention resides, briefly stated, in a clothing accessory which has at least one element of a clothing accessory, and a recording camera associated with said element of clothing accessory and carrying out a recording process while being associated with said element of clothing accessory.

In accordance with a further feature of the present invention, the recording camera is constructed to be arranged on the inner surface of the clothing accessory, and at least one or a plurality of clothing accessory pieces can be provided which are constructed to cover a front side of the camera, leaving unobstructed only an objective or a recording window of the camera, wherein the clothing accessory cover pieces can have different designs.

Still a further feature of the present invention is that the recording camera is constructed to carry out photography and videography, as well automated photography, for example, from 1 to 120 second delay with and without audio recording, in addition to video recording to record during a certain time or over a certain number of periods. These functions can be instructed by the software applications on a wireless remotely operating device, for example on a cellphone, a smartphone and the like.

A further feature of the present invention resides in that the recording camera is provided with a motion detecting element and is activated for recording when the motion detecting element detects a motion in a vicinity of the camera and therefore in the vicinity of a person who wears the clothing accessory.

Still a further feature of the present invention is that the recording camera is constructed to make a plurality of photos and/or videos, and has an activating member provided on the camera when the latter is supported by the clothing accessory and activated by a user to make the photos and/or videos.

A further feature of the present invention is that the camera is constructed as a wirelessly operated camera, and a remotely operating device is provided for operating the wireless camera.

In accordance with a further feature of the present invention, the wireless camera and/or the remotely operating device are constructed so that they can store photos, video images and/or audio messages recorded by the wireless camera.

In accordance with another feature of the present invention, the recording camera can be constructed to record photos during the video recording mode enabled by a wireless control device, for example by the software applications of a smartphone and the like.

A further feature of the present invention is that the clothing accessory can be attached to various surfaces and/or objects using cover pieces with adhesives, different mounts and/or clips.

The novel features of the present invention are set forth in particular in the appended claims.

The invention itself, however, both as to its construction and its manner of operation will be best understood from the following description of the preferred embodiments, which is accompanied by the following drawings.

### BRIEF DESCRIPTION OF THE DRAWINGS

FIG. 1 of the drawings is a view showing the clothing accessory according to the invention, with a clothing accessory cover piece, a recording camera, and a remotely operating control device;

FIG. 2 is a perspective view of the recording camera in accordance with the present invention;

FIGS. 3 and 4 are a front view and a side view of the clothing accessory in accordance with a further embodiment of the invention;

FIG. 5 is a view showing the recording camera with a clothing accessory cover piece in accordance with the invention;

FIG. 6 is a view showing a further embodiment of the inventive clothing accessory; and

FIGS. 7, 8 and 9 are views showing further embodiments of the clothing accessory in accordance with the invention.

### DESCRIPTION OF THE PREFERRED EMBODIMENTS

A clothing accessory in accordance with the present invention includes a clothing accessory that is identified as a whole with reference numeral 1. The clothing accessory 1 further has a recording camera that is identified as a whole with reference numeral 4. The recording camera 4 that is shown in FIG. 2 is constructed to carry out a recording process while being associated with the clothing accessory 1.

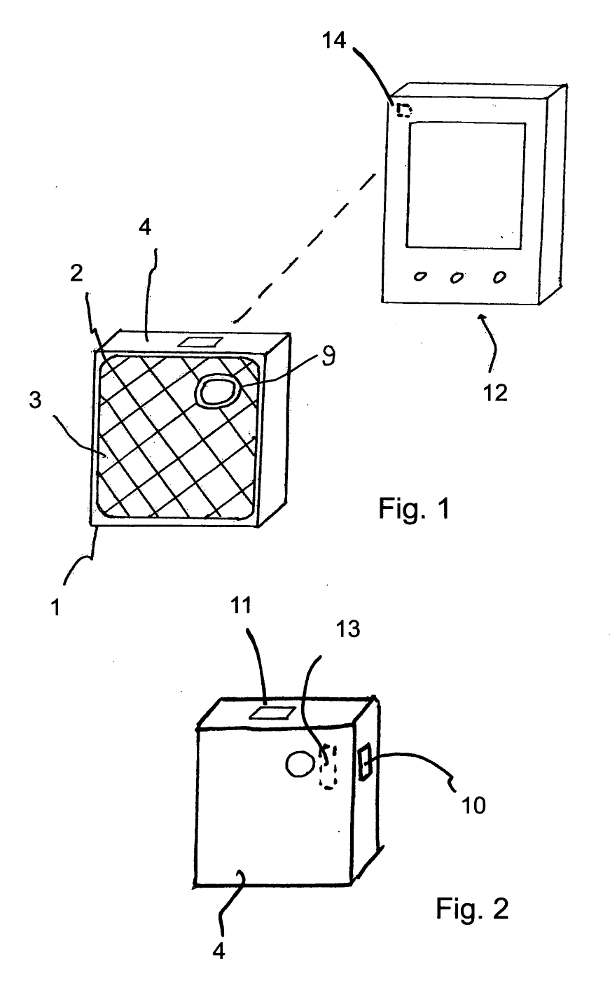

FIG. 1 shows that the clothing accessory 1 can be provided with at least one cover piece 2, attachable in any number of ways—adhesive, clipped on, wrapped around, etc—to the recording camera 4. The cover piece 2 can be of any shape, color, size, and/or material 3.

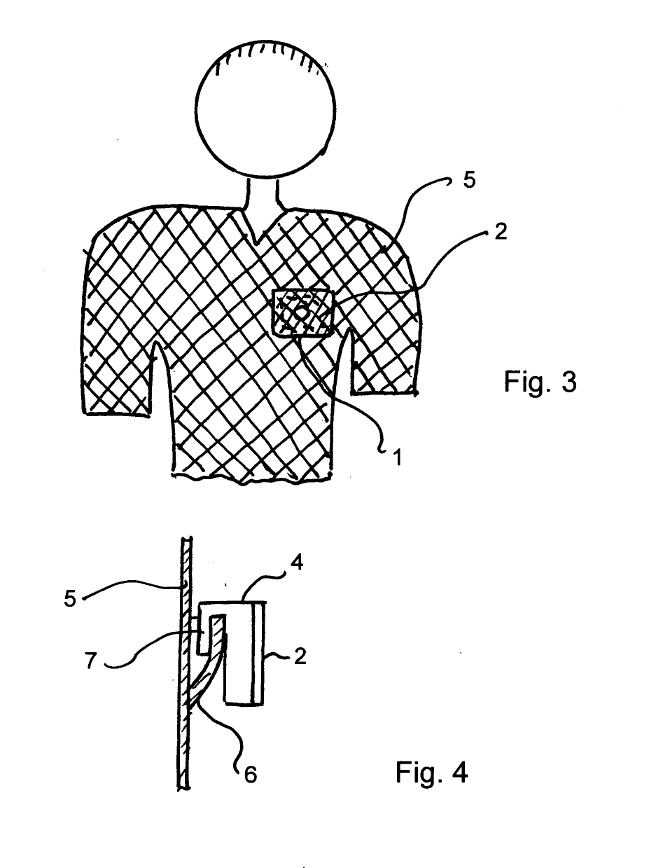

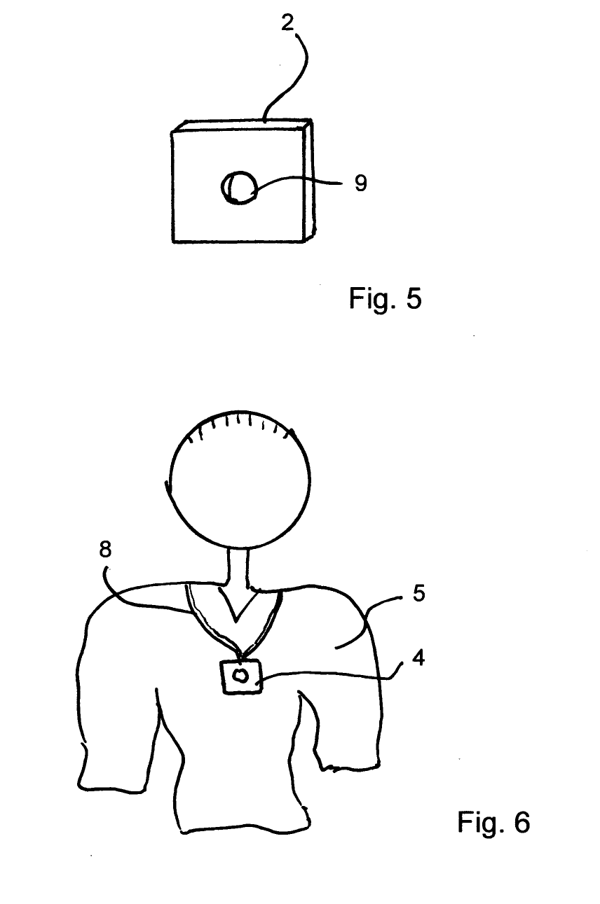

In accordance with another feature of the present invention shown in FIGS. 3-6 the clothing accessory 1 can be arranged on an outer surface of an element of clothing 5, for example being connected to the latter, in particular to the pocket 6, by a clip 7, or being suspended on a necklace 8, etc. In order to fit different clothing designs, fabrics and/or materials, a plurality of clothing accessory pieces 2 can be provided, each having a different face design 3 corresponding to the face design of the element of clothing 5. As an example, it can be seen from FIGS. 1, 3 and 5 that both the face of the element of clothing 5 and of the clothing accessory piece 2 have a square design. Each clothing accessory piece 2 has an opening 9 for the objective of the recording camera.

It is shown in FIG. 6 that the recording camera 4 can be suspended on a necklace or string 8 on the front surface of the element of clothing 5, and also can be covered by the clothing accessory piece 2 with a design which matches the design of the element of clothing 5.

The recording camera 4 can be constructed to carry out different types of a video recording with or without an audio recording. In particular it can carry out an automated photography, for example from 1 to 120 seconds delay with or without audio recording. It can also carry out a video recording to record during a certain time, or to record over a certain number of periods.

As shown in FIG. 2 the recording camera 4 can be provided with a motion detecting element 10. It is constructed so that it detects a motion in the vicinity of the camera and therefore of the user, and consequently activate the recording camera 4 automatically, just in response to the motion detection.

The recording camera 4 has a control or activating element 11 formed, for example, as a control button, with which the user operates to carry out the above mentioned recording processes carried out by the camera. The control or activating element 11 can also activate the recording camera to carry out making a plurality of photos.

While the recording process can be selected and activated directly on the recording camera 4 by the control or activating element 11, in accordance with another advantageous feature of the present invention the recording camera 4 can be constructed as wirelessly operating recording camera, and a remotely operating control device 12 can be provided for remotely operating the recording camera for carrying out by the latter all desired recording processes. The remotely operating control device 12 can be formed as any correspondingly constructed electronic device, such as a remote controller, a cellular telephone, etc.

In accordance with a still important and highly advantageous feature of the present invention the recording camera 4 and/or the remotely controlling device 12 can be constructed to be operated so that the recorded video images and/or audio messages can be stored in a memory 13 of the recording camera 4, or can be transferred to the remotely operating control device 12 and stored in a memory 14 of the latter, or both for a subsequent retrieval, for example for viewing, copying out, etc.

Furthermore, the recording camera 4 can be constructed so that it simultaneously carries out a photography recording during a video recording, and it can be remotely controlled by the remotely controlling device wirelessly, to store, exchange and reproduce after the storing the photo and video images recorded by the recording camera 4.

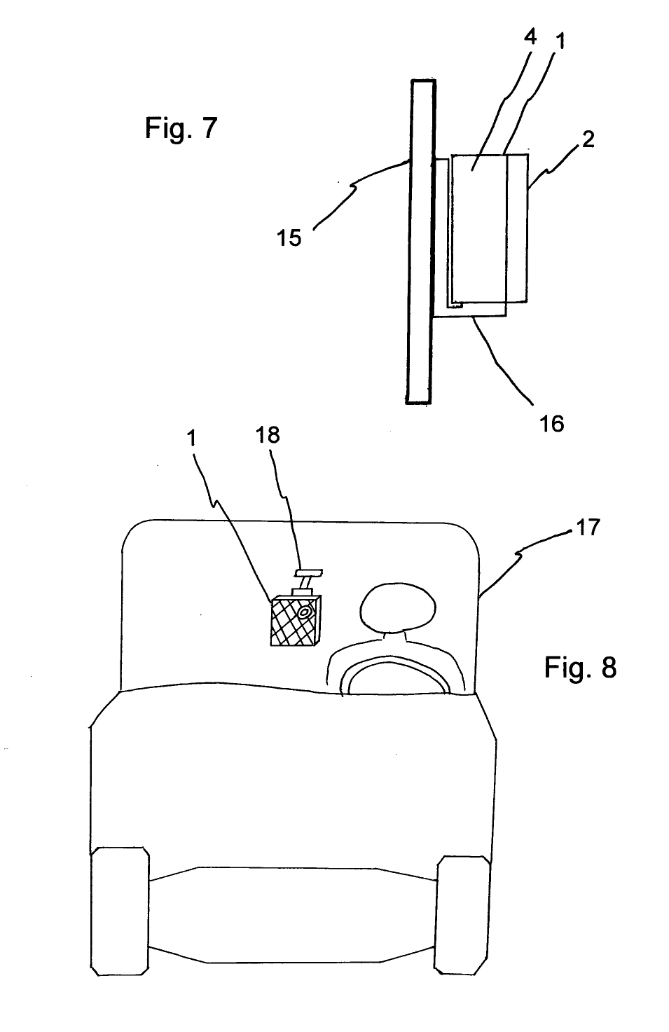

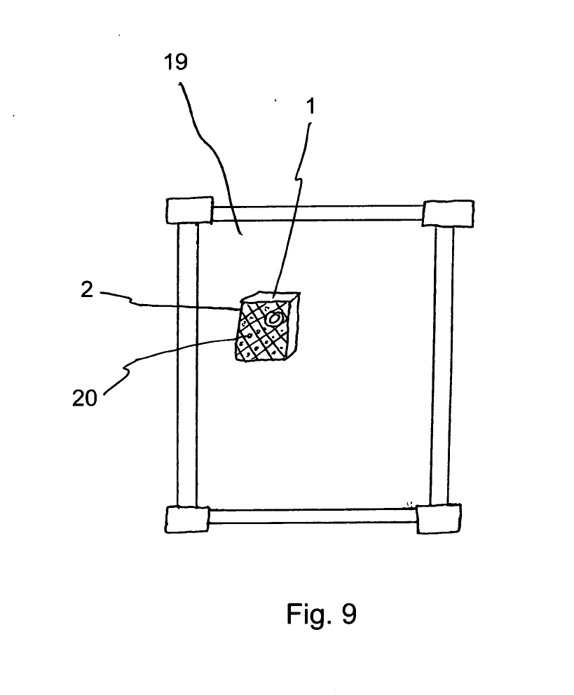

As shown in FIGS. 7, 8 and 9, the clothing accessory 1 can also be attached to different objects and/or surfaces, such as, but not limited to, walls 15, windshields 17, and/or windows 19. This is accomplished by utilizing different clips 16, mounts 18, or adhesives 20 depending on the surface. FIG. 9 shows the clothing accessory 1 attached to a window 19 with a clothing accessory piece 2 that includes adhesive 20 on the front face.

The invention is not limited to the details shown since various modifications and structural changes are possible without departing in any way from the spirit of the invention.

What is desired to be protected by Letters Patent is set forth in particular in the appended claims.

1. A clothing accessory comprised of at least one element of clothing accessory piece selected by a user attachable to a recording camera constructed to carry out a recording process while being associated with said element of clothing accessory.

2. A clothing accessory as defined in claim 1, wherein said camera is constructed to carry out recordings selected from the group consisting of an audio recording, a video recording, an automated photography with or without audio recording, a video recording to record over a certain time or over a number of periods, to make a plurality of photos, and combinations thereof.

3. A clothing accessory as defined in claim 1, wherein said camera is constructed to simultaneously carry out photography recording during video recording, and wherein said recording camera is remotely controllable with a wireless controlling device to store, exchange and reproduce after storing photo and video images recorded by said recording camera.

4. A clothing accessory as defined in claim 1, wherein said recording camera is constructed as a wirelessly operated recording camera, further comprising a remotely operating controlling device which is constructed to remotely control said recording camera to enable the latter to carry out the recording process, wherein said recording camera and/or said remotely operating control device are constructed to store, to exchange and to reproduce after storing video images and/or audio messages recorded by said recording camera.

5. A clothing accessory as defined in claim 1, wherein said camera is constructed to carry out recordings selected from the group consisting of an audio recording, a video recording, an automated photography with or without audio recording, a video recording to record over a certain time or over a number of periods, to make a plurality of photos, and combinations thereof, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

6. A clothing accessory as defined in to claim 1, wherein said camera is constructed to carry out recordings selected from the group consisting of an audio recording, a video recording, an automated photography with or without audio recording, a video recording to record over a certain time or over a number of periods, to make a plurality of photos, and combinations thereof, where said recording camera is also constructed to simultaneously carry out photography recording during video recording, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

7. A clothing accessory as defined in to claim 1, and further comprising a motion detecting element constructed to detect motion in a vicinity of the recording camera and to activate it to carry out the recording process in response to the detection of motion, wherein said camera is constructed to carry out recordings selected from the group consisting of an audio recording, a video recording, an automated photography with or without audio recording, a video recording to record over a certain time or over a number of periods, to make a plurality of photos, and combinations thereof, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

8. A clothing accessory as defined in to claim 1, and further comprising a motion detecting element constructed to detect motion in a vicinity of the recording camera and to activate it to carry out the recording process in response to the detection of motion, wherein said camera is constructed to carry out recordings selected from the group consisting of an audio recording, a video recording, an automated photography with or without audio recording, a video recording to record over a certain time or over a number of periods, to make a plurality of photos, and combinations thereof, where said recording camera is also constructed to simultaneously carry out photography recording during video recording, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

9. A clothing accessory as defined in claim 1, wherein said clothing accessory can be worn directly on clothing with various clips; can be worn around the neck by attaching to a lanyard or necklace of any material; can be attached to other objects or surfaces with various mounts, clips and/or adhesives; and wherein said element of clothing accessory piece can be any one of multiple designs, sizes, materials and/or shapes, and attachable to said recording camera.

10. A clothing accessory as defined in claim 9, wherein said camera is constructed to carry out recordings selected from the group consisting of an audio recording, a video recording, an automated photography with or without audio recording, a video recording to record over a certain time or over a number of periods, to make a plurality of photos, and combinations thereof.

11. A clothing accessory as defined in claim 9, wherein said camera is constructed to simultaneously carry out photography recording during video recording, and wherein said recording camera is remotely controllable with a wireless controlling device to store, exchange and reproduce after storing photo and video images recorded by said recording camera.

12. A clothing accessory as defined in claim 9, wherein said recording camera is constructed as a wirelessly operated recording camera, further comprising a remotely operating controlling device which is constructed to remotely control said recording camera to enable the latter to carry out the recording process, wherein said recording camera and/or said remotely operating control device are constructed to store, to exchange and to reproduce after storing video images and/or audio messages recorded by said recording camera.

13. A clothing accessory as defined in to claim 9, wherein said camera is constructed to carry out recordings selected from the group consisting of an audio recording, a video recording, an automated photography with or without audio recording, a video recording to record over a certain time or over a number of periods, to make a plurality of photos, and combinations thereof, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

14. A clothing accessory as defined in to claim 9, wherein said camera is constructed to carry out recordings selected from the group consisting of an audio recording, a video recording, an automated photography with or without audio recording, a video recording to record over a certain time or over a number of periods, to make a plurality of photos, and combinations thereof, where said recording camera is also constructed to simultaneously carry out photography recording during video recording, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

15. A clothing accessory as defined in to claim 9, and further comprising a motion detecting element constructed to detect motion in a vicinity of the recording camera and to activate it to carry out the recording process in response to the detection of motion, wherein said camera is constructed to carry out recordings selected from the group consisting of an audio recording, a video recording, an automated photography with or without audio recording, a video recording to record over a certain time or over a number of periods, to make a plurality of photos, and combinations thereof, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

16. A of clothing accessory as defined in claim 9, and further comprising a motion detecting element constructed to detect motion in a vicinity of the recording camera and to activate it to carry out the recording process in response to the detection of motion, wherein said camera is constructed to carry out recordings selected from the group consisting of an audio recording, a video recording, an automated photography with or without audio recording, a video recording to record over a certain time or over a number of periods, to make a plurality of photos, and combinations thereof, where said recording camera is also constructed to simultaneously carry out photography recording during video recording, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.
